(19) United States
(12) Patent Application Publication
(10) Pub. No.: US 2026/0112835 A1
(43) Pub. Date: Apr. 23, 2026

(54) ELECTRICAL CONNECTION ASSEMBLY WITH CONDUCTIVE FILM

(71) Applicant: DONGGUAN LUXSHARE TECHNOLOGIES CO.,LTD, Dongguan City (CN)

(72) Inventors: Kunlin YAO, Dongguan City (CN); Ruoyi Zhang, Dongguan City (CN)

(73) Assignee: DONGGUAN LUXSHARE TECHNOLOGIES CO.,LTD, Dongguan City (CN)

(21) Appl. No.: 18/930,497

(22) Filed: Oct. 29, 2024

(30) Foreign Application Priority Data
Oct. 22, 2024 (CN) 202411480904.9

(51) Int. Cl. H01R 13/24; H01R 12/70; H01R 12/79; H01R 13/50; H01R 13/621

(52) U.S. Cl. CPC H01R 13/2414; H01R 12/7047; H01R 12/79; H01R 13/50; H01R 13/6215

(57) ABSTRACT

An electrical connection assembly includes a connection module, a socket and a conductive film. The connection module includes a first housing and a number of first conductive elements. The first housing is provided with a first mounting wall. The socket includes a second housing and a number of second conductive elements. The second housing includes a receiving space and a second mounting wall. The conductive film includes a skeleton, an elastomer and a number of transfer conductive elements. The conductive film is received in the receiving space. The conductive film is sandwiched between the first mounting wall and the second mounting wall, and the elastomer is at least pressed by the connection module. The first conductive elements are electrically connected to the second conductive elements through the transfer conductive elements.

### CROSS-REFERENCE TO RELATED APPLICATION

This patent application claims priority of a Chinese Patent Application No. 202411480904.9, filed on Oct. 22, 2024 and titled “ELECTRICAL CONNECTION ASSEMBLY”, the entire content of which is incorporated herein by reference.

### TECHNICAL FIELD

The present disclosure relates to an electrical connection assembly, which belongs to the technical field of electrical connection.

### BACKGROUND

Electrical connection assemblies in the related art generally include a printed circuit board, a chip mounted to the printed circuit board, a plurality of socket connectors mounted to the printed circuit board, and a plurality of plug connectors at least partially received in the socket connectors. Each socket connector includes a plurality of socket conductive terminals. Each plug connector includes a plurality of plug conductive terminals. The plug conductive terminals mate with the socket conductive terminals so that the plug connector is electrically connected to the chip through the socket connector and the printed circuit board.

However, with the continuous improvement of signal transmission requirements, the electrical connection assemblies that use printed circuit boards as media require the use of conductive traces on the printed circuit board as signal transmission channels, so the signal loss is relatively large, and the signal transmission rate the signal transmission quality need to be further improved. Besides, the electrical connection assemblies using printed circuit boards as media take up a large volume and cause a lot of inconvenience to the layout of the socket connectors.

### SUMMARY

An object of the present disclosure is to provide an electrical connection assembly with a conductive film to shorten the conductive path and improve the quality of signal transmission.

In order to achieve the above object, the present disclosure adopts the following technical solution: an electrical connection assembly, including: a connection module, the connection module including a first housing and a plurality of first conductive elements, the first housing is provided with a first mounting wall, the first conductive elements being exposed to the first mounting wall; a socket, the socket including a second housing and a plurality of second conductive elements, the second housing including a receiving space and a second mounting wall, the second conductive elements being provided on the second mounting wall and exposed to the receiving space; and a conductive film, the conductive film including a skeleton, an elastomer fixed to the skeleton and a plurality of transfer conductive elements embedded in the elastomer; wherein the conductive film is received in the receiving space, the connection module is at least partially received in the receiving space, the conductive film is sandwiched between the first mounting wall and the second mounting wall, the elastomer is at least pressed by the connection module, and the first conductive elements are electrically connected to the second conductive elements through the transfer conductive elements.

In order to achieve the above object, the present disclosure adopts the following technical solution: an electrical connection assembly, including: a connection module, the connection module including a first housing and a plurality of first conductive elements, the first housing is provided with a first mounting wall, the first conductive elements being exposed to the first mounting wall; a socket, the socket including a second housing and a plurality of second conductive elements, the second housing including a receiving space and a second mounting wall, the second conductive elements being provided on the second mounting wall and exposed to the receiving space; a conductive film, the conductive film including a skeleton, an elastomer fixed to the skeleton and a plurality of transfer conductive elements fixed in the elastomer; and a chip, the chip being mounted to the second mounting wall, the chip including a plurality of conductive portions; wherein the conductive film is received in the receiving space, the connection module is at least partially received in the receiving space, the conductive film is sandwiched between the first mounting wall and the second mounting wall, and the first conductive elements are electrically connected to the conductive portions of the chip through the transfer conductive elements and the second conductive elements.

Compared with the prior art, the electrical connection assembly of the present disclosure includes the connection module, the socket and the conductive film. The conductive film is received in the receiving space. The connection module is at least partially received in the receiving space. The conductive film is sandwiched between the first mounting wall and the second mounting wall. The elastomer is at least pressed by the connection module. The first conductive elements are electrically connected to the second conductive elements through the transfer conductive elements. With this arrangement, the present disclosure shortens the conductive path, which is beneficial to improving the quality of signal transmission.

### BRIEF DESCRIPTION OF DRAWINGS

FIG. 1 is a schematic perspective view of an electrical connection assembly in accordance with a first embodiment of the present disclosure;

FIG. 2 is a perspective view of FIG. 1 from another angle;

FIG. 3 is a right view of FIG. 1;

FIG. 4 is a top view of FIG. 1;

FIG. 5 is a bottom view of FIG. 1;

FIG. 6 is a partially exploded perspective view of the electrical connection assembly of the present disclosure, in which a chip is separated;

FIG. 7 is a further exploded perspective view of FIG. 6;

FIG. 8 is a further perspective exploded view after removing the chip and a socket in FIG. 7, in which a conductive film is separated;

FIG. 9 is a partial enlarged view of circled part A in FIG. 8;

FIG. 10 is a partially exploded perspective view of the socket of the present disclosure;

FIG. 11 is a partially exploded perspective view of the electrical connection assembly of the present disclosure, in which a pressing plate and a first fastener are separated;

FIG. 12 is a further partially exploded perspective view of FIG. 11;

FIG. 13 is a partially exploded perspective view of FIG. 12 from another angle;

FIG. 14 is a perspective schematic view of the chip;

FIG. 15 is a perspective schematic view of the conductive film;

FIG. 16 is a perspective exploded view of the conductive film;

FIG. 17 is a partially exploded perspective view of the connection module;

FIG. 18 is a partially exploded perspective view of a cable module of the connection module;

FIG. 19 is a further exploded perspective view of FIG. 18;

FIG. 20 is an exploded perspective view of FIG. 19 from another angle;

FIG. 21 is a schematic cross-sectional view taken along line B-B in FIG. 4;

FIG. 22 is a partial enlarged view of frame portion C in FIG. 21;

FIG. 23 is a schematic perspective view of the electrical connection assembly in accordance with a second embodiment of the present disclosure;

FIG. 24 is a perspective view of FIG. 23 from another angle; and

FIG. 25 is a partially exploded perspective view of FIG. 24.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

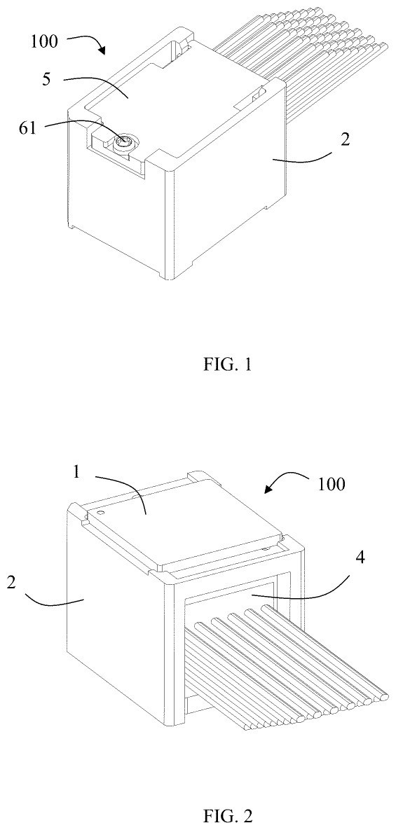

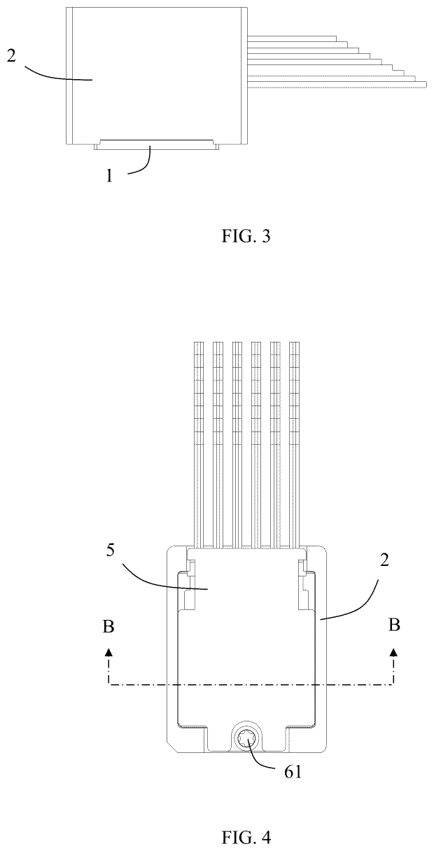

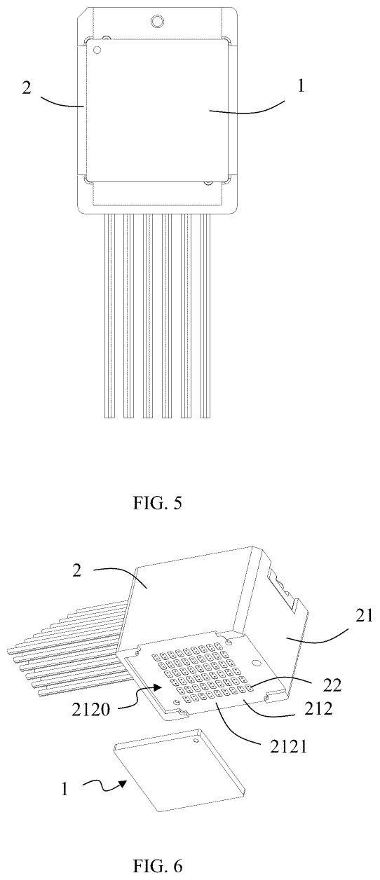

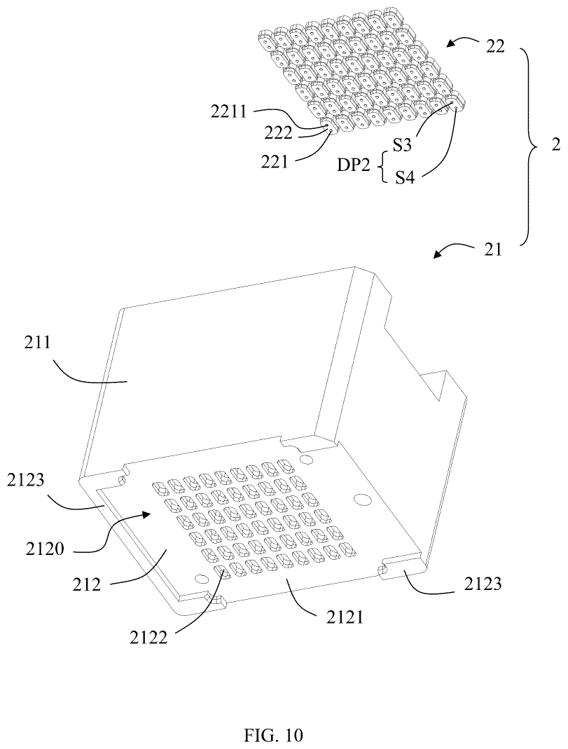

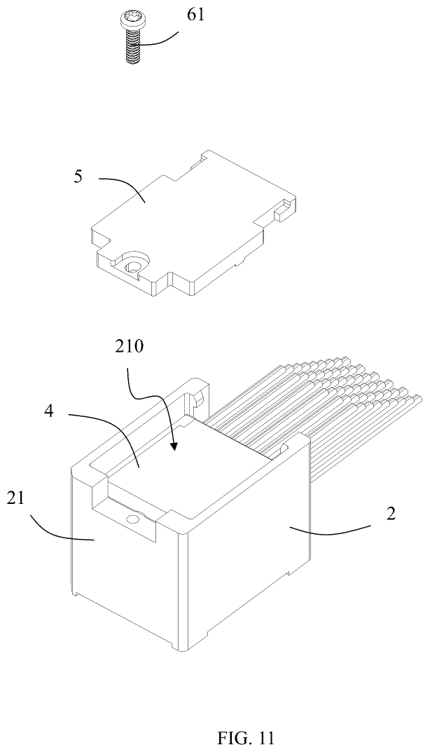

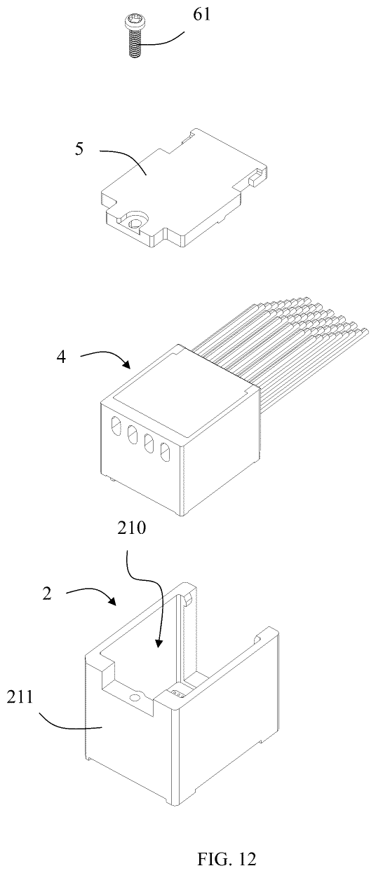

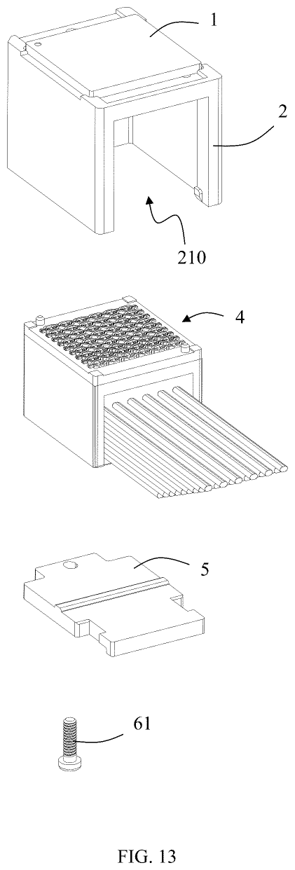

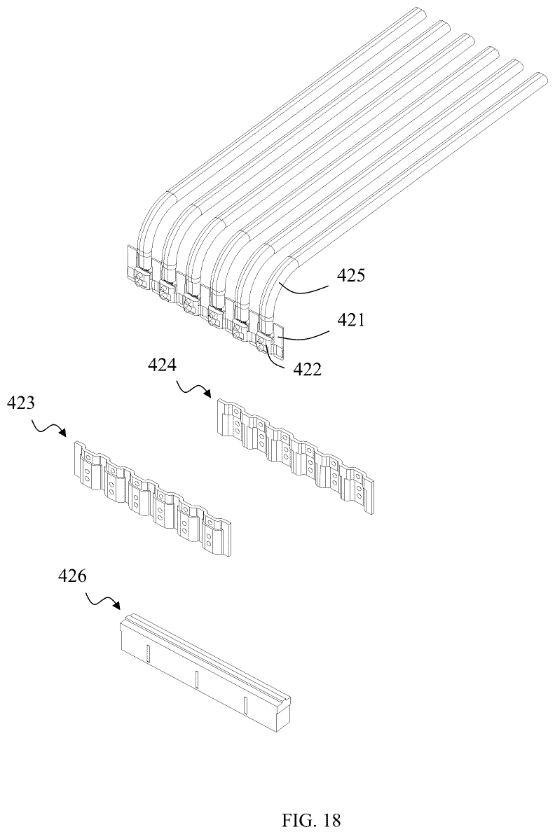

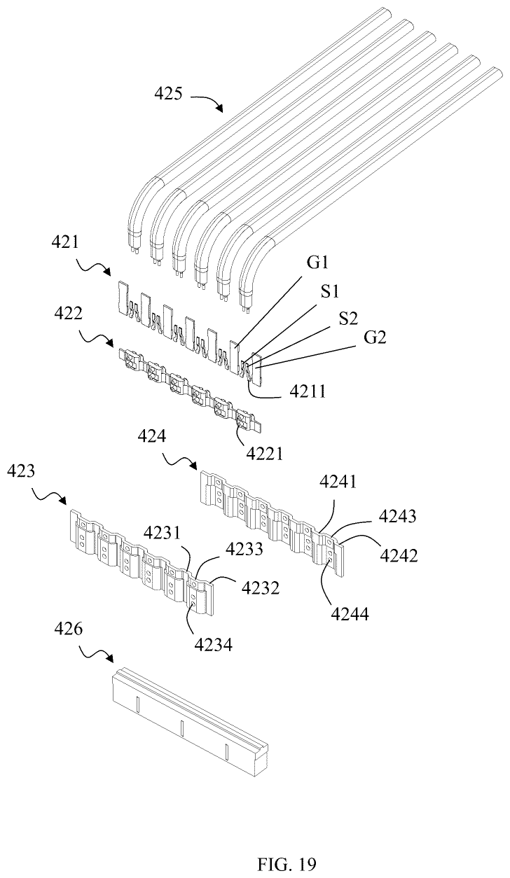

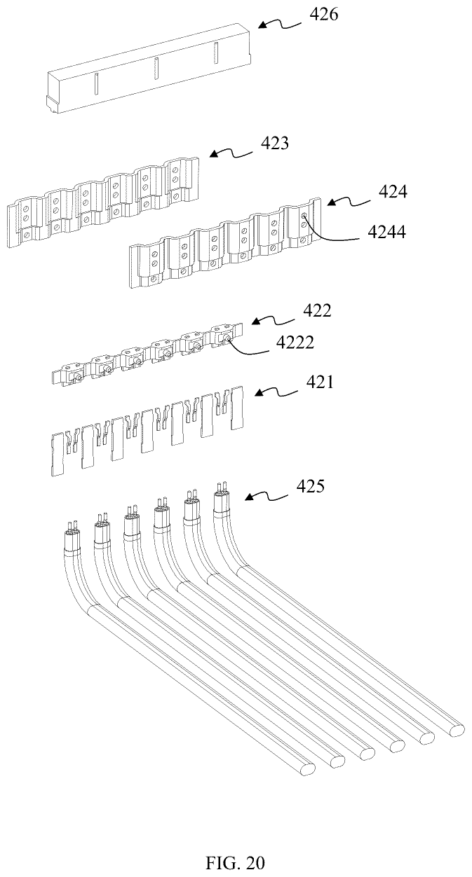

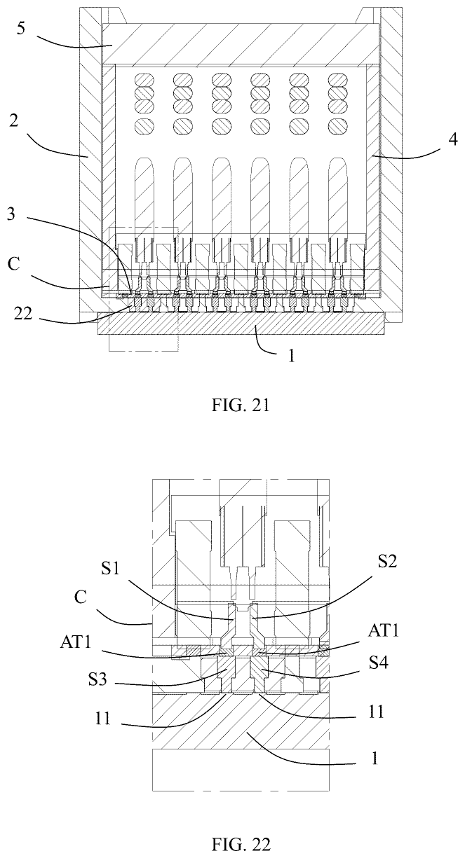

Referring to FIG. 1 to FIG. 22, a first embodiment of the present disclosure discloses an electrical connection assembly 100, which includes a chip 1, a socket 2 mounting together with the chip 1, a conductive film 3 received in the socket 2, a connection module 4 at least partially inserted into the socket 2, and a pressing plate 5 for pressing the connection module 4.

The connection module 4 includes a first housing 41, a plurality of cable modules 42 and a fixing block 43 fixed on the cable modules 42. In one embodiment of the present disclosure, the fixing block 43 is made of insulating material, and is over-molded on the cable modules 42 to be integrated as a whole.

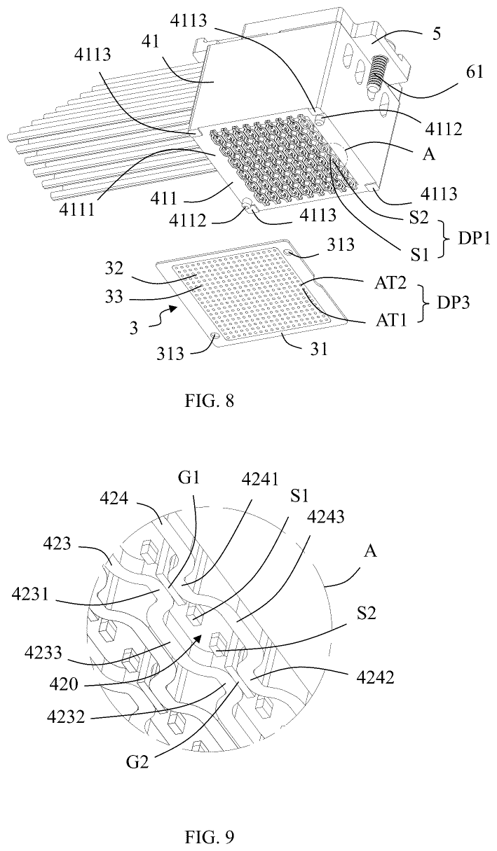

Referring to FIG. 8, in the illustrated embodiment of the present disclosure, the first housing 41 includes a first mounting wall 411 located at a bottom thereof. The first mounting wall 411 includes a first mating surface 4111, a plurality of positioning posts 4112 protruding downwardly from the first mating surface 4111, and a plurality of positioning protrusions 4113 protruding downwardly from the first mating surface 4111. In the illustrated embodiment of the present disclosure, two positioning posts 4112 are provided and arranged diagonally to improve the positioning accuracy. The positioning protrusions 4113 are located at four corners of the first mounting wall 411 to mate with the conductive film 3. In the illustrated embodiment of the present disclosure, the positioning posts 4112 extend downwardly beyond the positioning protrusions 4113.

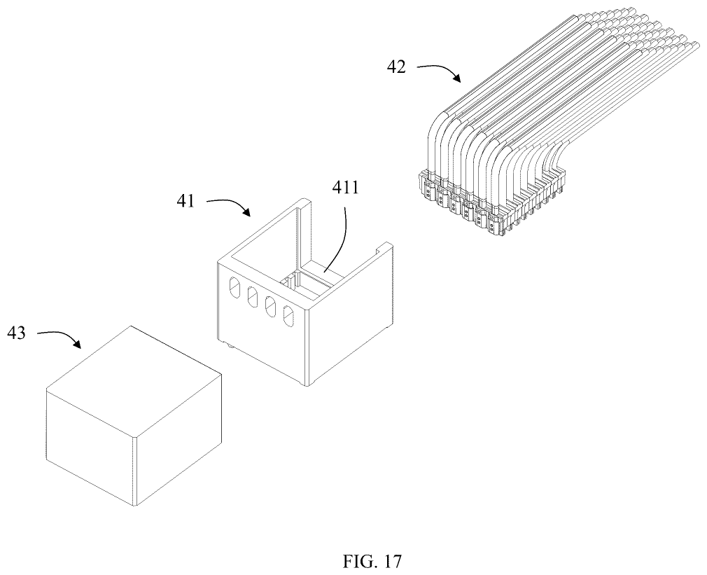

As shown in FIG. 17 to FIG. 20, each cable module 42 includes a plurality of first conductive elements 421, a first insulating block 422 fixed on the first conductive elements 421, a first metal shielding piece 423 installed on one side of the first insulating block 422, a second metal shielding piece 424 installed on another side of the first insulating block 422, a plurality of cables 425 connected to the first conductive elements 421, and a second insulating block 426 formed on the first metal shielding piece 423, the second metal shielding piece 424, the first insulating block 422 and the cables 425.

In the illustrated embodiment of the present disclosure, the first conductive elements 421 include a first signal conductive terminal S1, a second signal conductive terminal S2, a first ground conductive terminal G1 and a second ground conductive terminal G2. The first signal conductive terminal S1 and the second signal conductive terminal S2 form a first signal differential pair DP1 to increase the signal transmission rate. The first ground conductive terminal G1 and the second ground conductive terminal G2 are located on two sides of the first signal differential pair DP1, respectively, to improve the quality of signal transmission. The cable 425 is connected to the first signal conductive terminal S1 and the second signal conductive terminal S2. In the illustrated embodiment of the present disclosure, the width and height of the first ground conductive terminal G1 are respectively greater than the width and height of the first signal conductive terminal S1. The width and height of the first ground conductive terminal G1 are respectively greater than the width and height of the second signal conductive terminal S2. The width and height of the second ground conductive terminal G2 are respectively greater than the width and height of the first signal conductive terminal S1. The width and height of the second ground conductive terminal G2 are respectively greater than the width and height of the second signal conductive terminal S2. Each first conductive element 421 includes a non-elastic first contact portion 4211. In the illustrated embodiment of the present disclosure, the first contact portion 4211 is of a flat strip shape configuration.

In the illustrated embodiment of the present disclosure, the first insulating block 422 is formed on the first conductive elements 421 to be integral with the first conductive elements 421. The first contact portion 4211 of each first conductive element 421 extends downwardly and protrudes beyond the first insulating block 422. The first insulating block 422 includes a first protruding post 4221 on one side of the first insulating block 422 and a second protruding post 4222 provided on another side of the first insulating block 422. The first ground conductive terminal G1 and the second ground conductive terminal G2 both extend upwardly beyond the first insulating block 422.

In the illustrated embodiment of the present disclosure, the first metal shielding piece 423 is generally of a wavy shape configuration, and includes a first abutting portion 4231, a second abutting portion 4232, and a first raised portion 4233 connected between the first abutting portion 4231 and the second abutting portion 4232.

Similarly, the second metal shielding piece 424 is generally of a wavy shaped configuration, and includes a third contact portion 4241, a fourth contact portion 4242, and a second raised portion 4243 connected between the third contact portion 4241 and the fourth contact portion 4242. The first raised portion 4233 and the second raised portion 4243 have opposite raised directions. The first raised portion 4233 defines a first positioning hole 4234 that receives the first protruding post 4221. The second raised portion 4243 defines a second positioning hole 4244 that receives the second protruding post 4222.

Referring to FIG. 9, in the illustrated embodiment of the present disclosure, the first abutting portion 4231 and the third contact portion 4241 are in contact with opposite side surfaces of the first ground conductive terminal G1, respectively. The second abutting portion 4232 and the fourth contact portion 4242 are in contact with two opposite side surfaces of the second ground conductive terminal G2, respectively. The first abutting portion 4231, the first raised portion 4233, the second abutting portion 4232, the second ground conductive terminal G2, the fourth contact portion 4242, and the second raised portion 4243, the third contact portion 4241 and the first ground conductive terminal G1 together form a shielding cavity 420. The first signal conductive terminal S1 and the second signal conductive terminal S2 are at least partially resides in the shielding cavity 420 to improve the quality of signal transmission.

Referring to FIG. 8 and FIG. 9, in the illustrated embodiment of the present disclosure, the shielding cavity 420 is exposed to the first mounting wall 411. The first contact portion 4211 of the first signal conductive terminal S1, the first contact portion 4211 of the second signal conductive terminal S2, the first contact portion 4211 of the first ground conductive terminal G1, the first contact portion 4211 of the second ground conductive terminal G2, the first metal shielding piece 423, and the second metal shielding piece 424 all extend downwardly beyond the first mating surface 4111.

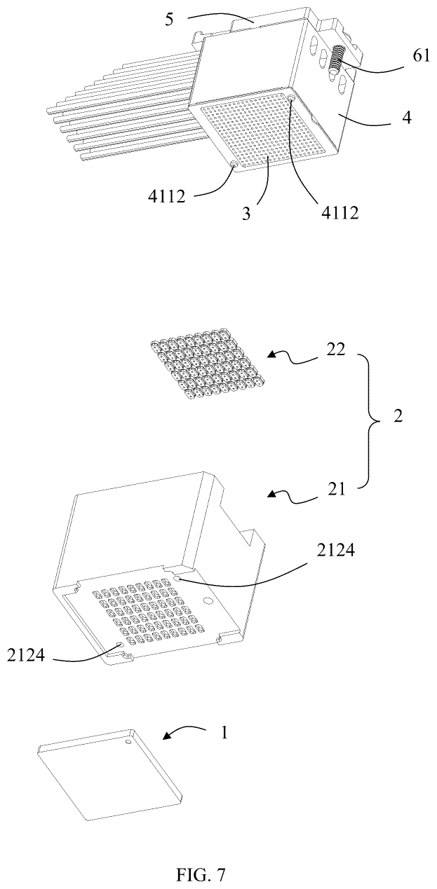

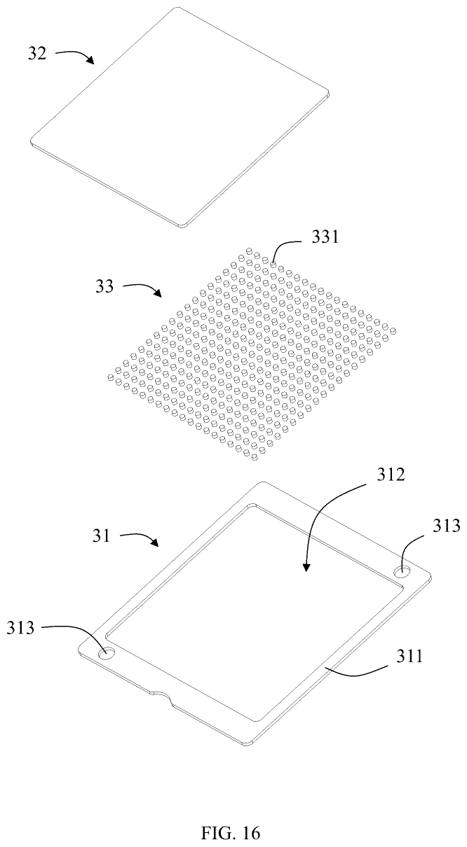

Referring to FIG. 7, FIG. 8, FIG. 15 and FIG. 16, in the illustrated embodiment of the present disclosure, the conductive film 3 includes a skeleton 31, an elastomer 32 fixed to the skeleton 31, and a plurality of transfer conductive elements 33 embedded in the elastomer 32. In one embodiment of the present disclosure, the skeleton 31 is a metal base plate (for example, a steel frame structure) to provide better structural strength. The skeleton 31 is provided with a surrounding frame 311 and a filling space 312 located within the frame 311. The surrounding frame 311 is beneficial to ensuring the structural strength.

In one embodiment of the present disclosure, the elastomer 32 is a silicone elastomer. That is, the elastomer 32 is made of silicone, so that it has a certain elastic deformation ability. The elastomer 32 is filled in the filling space 312 to be fixed with the frame 31. It is understandable to those skilled in the art that the elastomer 32 will undergo compression deformation due to an external force, which is beneficial to absorbing the flatness error of the contact components.

Each transfer conductive element 33 includes transfer contact portions 331 respectively located at its upper and lower ends. The transfer conductive elements 33 include a first transfer terminal AT1 and a second transfer terminal AT2. The first transfer terminal AT1 and the second transfer terminal AT2 form a third signal differential pair DP3 to improve the quality of signal transmission.

In the illustrated embodiment of the present disclosure, the skeleton 31 of the conductive film 3 defines a plurality of first positioning through holes 313 to mate with the positioning posts 4112. The positioning protrusions 4113 are supported on the skeleton 31 of the conductive film 3 to prevent the connection module 4 from over-pressing the conductive film 3 and causing damage to the conductive film 3.

The socket 2 includes a second housing 21 and a plurality of terminal modules 22. The second housing 21 is provided with an outer peripheral wall 211, a receiving space 210 surrounded by the outer peripheral wall 211, and a second mounting wall 212 located at a bottom of the receiving space 210.

The second mounting wall 212 is provided with a second mounting surface 2121 facing away from the receiving space 210, a plurality of mounting holes 2122 extending through the second mounting wall 212 and communicating with the receiving space 210, and at least one protruding portion 2123 protruding downwardly from the second mounting surface 2121. The protruding portion 2123 forms an accommodation space 2120. The second mounting surface 2121 is exposed to the accommodation space 2120. The chip 1 is at least partially accommodated in the accommodation space 2120.

In the illustrated embodiment of the present disclosure, each terminal module 22 includes a plurality of second conductive elements 221 and an insulator 222. The second conductive elements 221 are fixed in the insulator 222. The terminal module 22 is installed in the mounting hole 2122. One end of the second conductive element 221 is exposed in the receiving space 210 so as to be in contact with the transfer conductive element 33 of the conductive film 3, and another end of the second conductive element 221 is exposed in the accommodation space 2120 to be in contact with the chip 1 and thereby be electrically connected to the chip 1.

In the illustrated embodiment of the present disclosure, each second conductive element 221 includes non-elastic second contact portions 2211 located at two ends thereof. The second conductive elements 221 include a third signal conductive terminal S3 and a fourth signal conductive terminal S4. The third signal conductive terminal S3 and the fourth signal conductive terminal S4 form a second signal differential pair DP2 to increase the signal transmission rate.

Besides, the second mounting wall 212 defines a second positioning through hole 2124 that extends through the second mounting wall 212 and communicates with the receiving space 210. The positioning post 4112 inserted into the first positioning through hole 313 and protruding beyond the skeleton 31 is inserted into the second positioning through hole 2124 to achieve positioning.

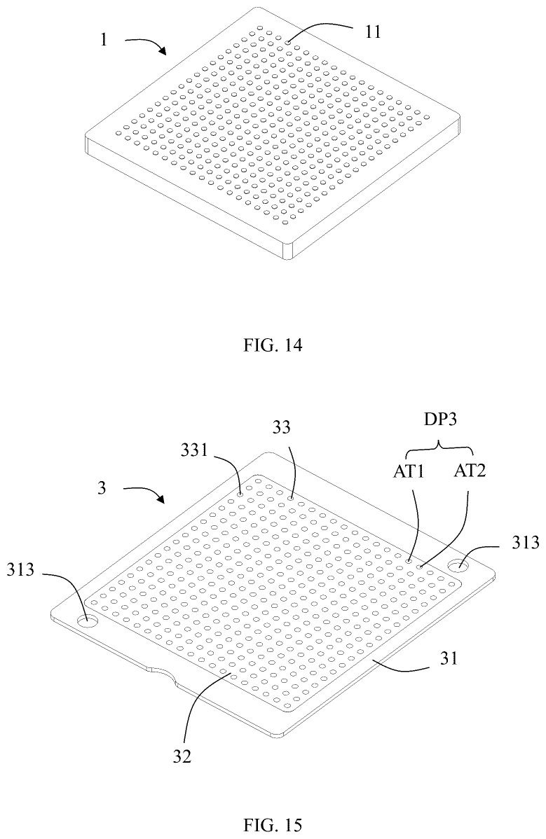

As shown in FIG. 14, the chip 1 (including but not limited to a central processing unit, CPU) is provided with a plurality of conductive portions 11. The conductive portions 11 are exposed on at least one side surface (for example, an upper surface) thereof to be in contact with the second conductive elements 221.

It is understandable to those skilled in the art that the connection module 4, the conductive film 3, the socket 2 and the chip 1 of the present disclosure are connected in sequence. The conductive film 3 is received in the receiving space 210. The connection module 4 is at least partially received in the receiving space 210. The conductive film 3 is sandwiched between the first mounting wall 411 and the second mounting wall 212. The elastomer 32 is at least pressed by the connection module 4 to absorb the flatness error of the contact component. The first conductive elements 421 are electrically connected to the second conductive elements 221 through the transfer conductive elements 33. Specifically, in the illustrated embodiment of the present disclosure, the first transfer terminals AT1 connect the first signal conductive terminals S1 and the third signal conductive terminals S3. The second transfer terminals AT2 connect the second signal conductive terminals S2 and the fourth signal conductive terminals S4. As a result, the first conductive elements 421 are electrically connected to the conductive portions 11 of the chip 1 through the transfer conductive elements 33 and the second conductive elements 221.

In order to improve contact reliability, the pressing plate 5 covers the connection module 4 and holds the connection module 4 in the receiving space 210. The electrical connection assembly 100 further includes a first fastener 61 (for example, a screw) that passes through the pressing plate 5 and is fixed to the second housing 21.

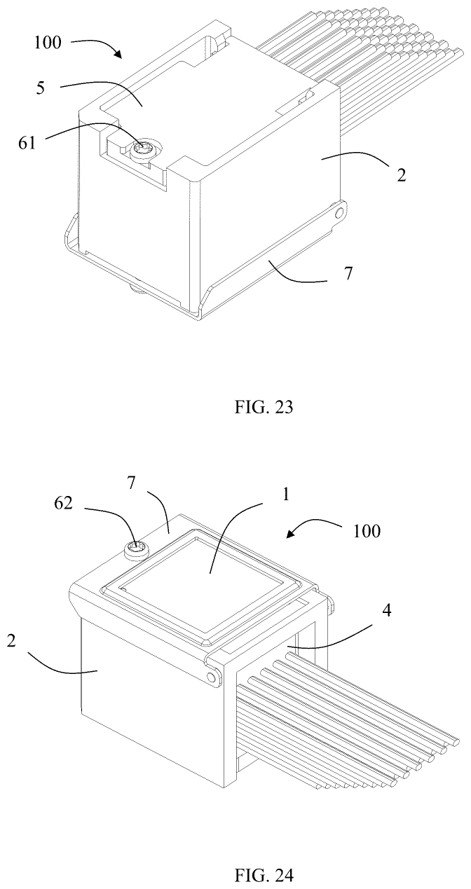

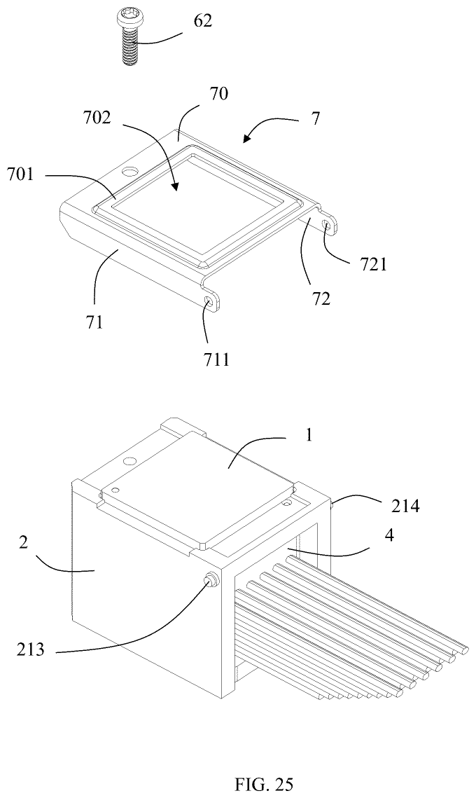

Referring to FIG. 23 to FIG. 25, in a second embodiment of the electrical connection assembly 100 of the present disclosure, the electrical connection assembly 100 further includes a retaining cover 7. The retaining cover 7 is mounted to the second housing 21 to hold the chip 1 between the second mounting wall 212 and the retaining cover 7.

Specifically, the second housing 21 is provided with a first pivot post 213 and a second pivot post 214. The retaining cover 7 includes a cover plate 70, a first side wall 71 bent from one side of the cover plate 70, and a second side wall 72 bent from another side of the cover plate 70. The cover plate 70 is provided with a bump portion 701 protruding away from the chip 1 and an opening 702 extending through the bump portion 701. The chip 1 is at least partially received in the bump portion 701 and exposed to the opening 702 to improve heat dissipation. The first side wall 71 is provided with a first pivot hole 711 that receives the first pivot post 213. The second side wall 72 is provided with a second pivot hole 721 that receives the second pivot post 214. The retaining cover 7 is rotatable with respect to the second housing 21 along the first pivot post 213 and the second pivot post 214.

It is understandable to those skilled in the art that when installing the chip 1, the retaining cover 7 is firstly rotated and opened. Then, the chip 1 is installed. Finally, the retaining cover 7 is rotated and closed. In the illustrated embodiment of the present disclosure, in order to fix the retaining cover 7, the electrical connection assembly 100 further includes a second fastener 62 (for example, a screw) passing through the cover plate 70 to fix the cover plate 70 to the second mounting wall 212.

Compared with the prior art, the electrical connection assembly 100 of the present disclosure includes the connection module 4, the socket 2 and the conductive film 3. The conductive film 3 is received in the receiving space 210. The connection module 4 is at least partially received in the receiving space 210. The conductive film 3 is sandwiched between the first mounting wall 411 and the second mounting wall 212. The elastomer 32 is at least pressed by the connection module 4. The first conductive elements 421 are electrically connected to the second conductive elements 221 through the transfer conductive elements 33, and finally are electrically connected to the chip 1. With this arrangement, the electrical connection assembly 100 of the present disclosure shortens the conductive path, reduces losses, and helps improve the quality of signal transmission. In addition, the electrical connection assembly 100 of the present disclosure can omit a printed circuit board, thereby improving the flexibility of component arrangement and saving costs.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connection assembly, comprising:
a connection module, the connection module comprising a first housing and a plurality of first conductive elements, the first housing is provided with a first mounting wall, the first conductive elements being exposed to the first mounting wall;
a socket, the socket comprising a second housing and a plurality of second conductive elements, the second housing comprising a receiving space and a second mounting wall, the second conductive elements being provided on the second mounting wall and exposed to the receiving space; and
a conductive film, the conductive film comprising a skeleton, an elastomer fixed to the skeleton and a plurality of transfer conductive elements embedded in the elastomer;
wherein the conductive film is received in the receiving space, the connection module is at least partially received in the receiving space, the conductive film is sandwiched between the first mounting wall and the second mounting wall, the elastomer is at least pressed by the connection module, and the first conductive elements are electrically connected to the second conductive elements through the transfer conductive elements.

2. The electrical connection assembly according to claim 1, wherein each first conductive element comprises a non-elastic first contact portion; the first conductive elements comprise a first signal conductive terminal and a second signal conductive terminal;
each second conductive element comprises a non-elastic second contact portion; the second conductive elements comprise a third signal conductive terminal and a fourth signal conductive terminal;
each transfer conductive element comprises a transfer contact portion; the transfer conductive elements comprise a first transfer terminal and a second transfer terminal;
the first transfer terminal is connected between the first signal conductive terminal and the third signal conductive terminal, and the second transfer terminal is connected between the second signal conductive terminal and the fourth signal conductive terminal.

3. The electrical connection assembly according to claim 2, wherein the first signal conductive terminal and the second signal conductive terminal form a first signal differential pair;
the third signal conductive terminal and the fourth signal conductive terminal form a second signal differential pair; and
the first transfer terminal and the second transfer terminal form a third signal differential pair.

4. The electrical connection assembly according to claim 1, wherein the first signal conductive terminal and the second signal conductive terminal form a first signal differential pair;
the first conductive elements further comprise a first ground conductive terminal and a second ground conductive terminal; and the first ground conductive terminal and the second ground conductive terminal are located on two sides of the first signal differential pair, respectively.

5. The electrical connection assembly according to claim 4, wherein the connection module comprises a first metal shielding piece and a second metal shielding piece;
the first metal shielding piece comprises a first abutting portion, a second abutting portion, and a first raised portion connected between the first abutting portion and the second abutting portion;
the second metal shielding piece comprises a third abutting portion, a fourth abutting portion, and a second raised portion connected between the third abutting portion and the fourth abutting portion; the first raised portion and the second raised portion have opposite raised directions;
the first abutting portion and the third abutting portion are in contact with two opposite side surfaces of the first ground conductive terminal, respectively; the second abutting portion and the fourth abutting portion are in contact with two opposite side surfaces of the second ground conductive terminal, respectively; the first abutting portion, the first raised portion, the second abutting portion, the second ground conductive terminal, the fourth abutting portion, the second raised portion, the third abutting portion and the first ground conductive terminal together form a shielding cavity in which the first signal conductive terminal and the second signal conductive terminal reside.

6. The electrical connection assembly according to claim 5, wherein the shielding cavity is exposed to the first mounting wall.

7. The electrical connection assembly according to claim 5, wherein the connection module comprises a first insulating block formed on the first signal conductive terminal, the second signal conductive terminal, the first ground conductive terminal and the second ground conductive terminal; the first insulating block comprises a first protruding post provided on one side thereof, and a second protruding post provided on another side thereof;
the first raised portion defines a first positioning hole to receive the first protruding post; the second raised portion defines a second positioning hole to receive the second protruding post.

8. The electrical connection assembly according to claim 7, wherein the connection module comprises a cable connected to the first signal conductive terminal and the second signal conductive terminal;
the connection module further comprises a second insulating block formed on the first metal shielding piece, the second metal shielding piece, the first insulating block and the cable.

9. The electrical connection assembly according to claim 1, wherein the first mounting wall comprises a first mating surface beyond which the first conductive elements extend;
the first mounting wall further comprises at least one positioning post; the skeleton of the conductive film defines at least one first positioning through hole; the at least one positioning post passes through the first positioning through hole and extends out of the skeleton.

10. The electrical connection assembly according to claim 9, wherein the second mounting wall defines at least one second positioning through hole that extend through the second mounting wall and communicates with the receiving space; the at least one positioning post extending through the at least one first positioning through hole and extending out of the skeleton is inserted into the at least one second positioning through hole.

11. The electrical connection assembly according to claim 9, wherein the first mounting wall comprises a plurality of positioning protrusions protruding beyond the first mating surface; the positioning protrusions are located at four corners of the first mounting wall; the positioning protrusions are supported on the skeleton of the conductive film; the at least one positioning post extends beyond the positioning protrusions.

12. The electrical connection assembly according to claim 1, wherein the second mounting wall comprises a second mounting surface facing away from the receiving space and a plurality of mounting holes that extend through the second mounting wall and communicate with the receiving space;
the socket comprises a plurality of terminal modules, each terminal module comprises the second conductive elements and an insulator, the second conductive elements are fixed in the insulator, the terminal module is installed in the mounting hole.

13. The electrical connection assembly according to claim 1, further comprising a pressing plate covering the connection module and retaining the connection module in the receiving space.

14. The electrical connection assembly according to claim 13, further comprising a first fastener passing through the pressing plate and fixed to the second housing.

15. The electrical connection assembly according to claim 1, further comprising a chip mounted to the second mounting wall; the second conductive elements being in contact with the chip; the first conductive elements being electrically connected to the chip through the transfer conductive elements and the second conductive elements.

16. The electrical connection assembly according to claim 15, wherein the second mounting wall comprises a second mounting surface facing away from the receiving space and at least one protruding portion protruding from the second mounting surface; the at least one protruding portion forms an accommodation space; the second mounting surface is exposed to the accommodation space; the chip is at least partially accommodated in the accommodation space.

17. The electrical connection assembly according to claim 15, further comprising a retaining cover; the retaining cover being mounted to the second housing to retain the chip between the second mounting wall and the retaining cover.

18. The electrical connection assembly according to claim 17, wherein the second housing comprises a first pivot post and a second pivot post;
the retaining cover comprises a cover plate, a first side wall bent from one side of the cover plate, and a second side wall bent from another side of the cover plate; the cover plate comprises a bump portion protruding away from the chip and an opening extending through the bump portion; the chip is at least partially received in the bump portion and exposed to the opening; the first side wall defines a first pivot hole that receives the first pivot post; the second side wall defines a second pivot hole that receives the second pivot post; the retaining cover is rotatable with respect to the second housing along the first pivot post and the second pivot post.

19. The electrical connection assembly according to claim 18, further comprising a second fastener passing through the cover plate to secure the cover plate to the second mounting wall.

20. An electrical connection assembly, comprising:
a connection module, the connection module comprising a first housing and a plurality of first conductive elements, the first housing is provided with a first mounting wall, the first conductive elements being exposed to the first mounting wall;
a socket, the socket comprising a second housing and a plurality of second conductive elements, the second housing comprising a receiving space and a second mounting wall, the second conductive elements being provided on the second mounting wall and exposed to the receiving space;
a conductive film, the conductive film comprising a skeleton, an elastomer fixed to the skeleton and a plurality of transfer conductive elements fixed in the elastomer; and
a chip, the chip being mounted to the second mounting wall, the chip comprising a plurality of conductive portions;
wherein the conductive film is received in the receiving space, the connection module is at least partially received in the receiving space, the conductive film is sandwiched between the first mounting wall and the second mounting wall, and the first conductive elements are electrically connected to the conductive portions of the chip through the transfer conductive elements and the second conductive elements.
